(19) United States
(12) Patent Application Publication
(10) Pub. No.: US 2025/0301945 A1
(43) Pub. Date: Oct. 2, 2025

(54) DEVICES, METHODS, AND COMPOSITIONS FOR ENHANCING COVERAGE AND RETENTION OF LIQUID SOLUTIONS SPRAYED ON PLANT SURFACES

(71) Applicant: AgZen Inc., Somerville, MA (US)

(72) Inventors: Vishnu Jayaprakash, Somerville, MA (US); Kripa Kiran Varanasi, Lexington, MA (US)

(21) Appl. No.: 18/956,199

(22) Filed: Nov. 22, 2024

Related U.S. Application Data
(60) Provisional application No. 63/601,819, filed on Nov. 22, 2023.

(51) Int. Cl. A01C 23/04; A01M 7/00; B05B 1/14

(52) U.S. Cl. CPC A01C 23/047; A01M 7/0032; B05B 1/14

(57) ABSTRACT

Presented herein are systems, methods, and devices for enhancing coverage and retention of liquid solutions sprayed onto plant surfaces. More particularly, in certain embodiments, presented herein are systems, methods, and devices for distributing adjuvant in sprayed droplets to concentrate adjuvant within a partial volume near to the droplet surface (e.g., a “cloaking volume”), with lower adjuvant concentration in a bulk interior volume that includes the droplet center.

### CROSS-REFERENCE TO RELATED APPLICATIONS

This application claims priority to and benefit of U.S. Provisional Patent Application No. 63/601,819 filed Nov. 22, 2023, the disclosure of which is incorporated herein by reference in its entirety.

### FIELD

This invention relates generally to agricultural systems and methods. More particularly, in certain embodiments, the invention relates to devices, methods, and compositions for enhancing coverage and retention of liquid solutions sprayed onto plant surfaces.

### BACKGROUND

Pesticide pollution is linked to acute illnesses such as cancer, neurological conditions, and birth defects. Furthermore, excess pesticides adversely affect soil chemistry and cause the death of non-target organisms, damaging soil microbiomes responsible for replenishing plant nutrients. Moreover, pesticides represent a major financial burden for farmers, for example, making up about 30% of the total production costs for crops such as cotton. Thus, it is important to improve the efficiency of pesticide application to reduce the amount of pesticide used while achieving efficacious pest control.

Agrochemicals such as pesticides, foliar fertilizer, and nutrient formulations are usually applied to plants in liquid solutions using pressure-controlled spray systems. Foliar solutions (foliar fertilizers) and pesticide solutions are applied directly to the surface of plants (e.g., a surface of a leaf, a surface of a root, a surface of a fruit, a surface of a vegetable, or a surface of a flower of the plant) as opposed to being put in the soil. In such agrochemical spray systems, pressurized pesticide solutions and/or foliar solutions are forced through nozzles at specific flow rates to achieve spray patterns that cover leaves or other plant surfaces with a significant number of droplets. For pesticide sprays to be efficacious in controlling pests and for foliar solutions to be efficacious as fertilizer, it is critical to achieve a high degree of liquid coverage (e.g., droplets, films, and/or pools of liquid) and liquid retention on target plant surfaces.

Spray adjuvants have been developed to increase the ability of a sprayed-on solution to stick to target plant surfaces and decrease the amount that evaporates or washes off due to environmental conditions such as rain or irrigation. However, the role of adjuvants in droplet behavior is not fully understood. Using too little adjuvant may not enhance droplet sticking, while using too much adjuvant may interfere with active ingredients in the sprayed-on solution and lead to phytotoxicity.

There is a need for improved technology that enhances liquid coverage and retention of solutions sprayed on target plant surfaces without inflicting phytotoxic damage.

### SUMMARY

Presented herein are systems, methods, and devices for enhancing coverage and retention of liquid solutions sprayed onto plant surfaces. More particularly, in certain embodiments, presented herein are systems, methods, and devices for distributing adjuvant in sprayed droplets to concentrate adjuvant within a partial volume near to the droplet surface (e.g., a “cloaking volume”), with lower adjuvant concentration in a bulk interior volume that includes the droplet center. In certain embodiments, the cloaking volume has a value in a range from about 0.1V to about 0.5V (e.g., from about 0.15V to about 0.3V, e.g., a cloaking volume of about 0.2V), where V is total droplet volume. In certain embodiments, the cloaking volume has an adjuvant concentration in a range from about 2.5 C to about 8 C (e.g., from about 3 C to about 6 C, e.g., an adjuvant concentration of about 4 C), where 1 C is total amount of adjuvant (e.g., mass) divided by total droplet volume.

Further presented herein are particular non-oil adjuvant solutions that work well with this improved cloaking technique.

Moreover, presented herein are nozzles and spraying systems particularly well-suited for performing the improved cloaking technique. In certain embodiments, the nozzle comprises (i) a primary fluid inlet and channel for directing a first stream (e.g., water or an aqueous solution, e.g., an agrochemical solution, e.g., a pesticide solution) to a first nozzle outlet and (ii) a secondary fluid inlet and channel for directing a second stream (e.g., adjuvant solution) to a second nozzle outlet, said first nozzle outlet and second nozzle outlet positioned in relation to each other (e.g., at respective angles) to direct their respective streams to meet [e.g., for cloaking of droplets of the aqueous solution (e.g., water, agrochemical solution, or pesticide solution) with adjuvant solution]. In certain embodiments, the nozzle comprises a deflector plate (e.g., located at or near the first nozzle outlet) to deflect fluid from the first stream exiting the first nozzle outlet (e.g., to deflect the first stream into a fan shape). In certain embodiments, the nozzle comprises a deflector plate (e.g., located at or near the second nozzle outlet) to deflect fluid from the second stream exiting the second nozzle outlet (e.g., to deflect the second stream into a fan shape). In certain embodiments, the second nozzle outlet comprises multiple orifices (e.g., multiple orifices positioned on a common plane, e.g., wherein the second nozzle outlet comprises multiple orifices positioned on a plane at an acute angle (e.g., less than 90 degrees, e.g., between 20 and 80 degrees, e.g., between 30 and 70 degrees) with respect to a plane of the first nozzle outlet). In certain embodiments, the nozzle has the configuration depicted in FIG. 4, or any of FIGS. 7 to 23.

Various cloaking methods, compositions, and devices are described in U. S. Patent Application Publication No. US 2023/0135222, published May 4, 2023, “Compositions, Articles, Devices, and Methods Related to Droplets Comprising a Cloaking Fluid,” by Varanasi et al., filed Oct. 27, 2022, the text of which is incorporated herein by reference in its entirety.

Presented hereinbelow are improvements of these cloaking methods, compositions, and devices.

In one aspect, the invention is directed to a method of applying a solution to plant surfaces, the method comprising contacting a first liquid and an adjuvant (e.g., a second liquid comprising the adjuvant, e.g., an adjuvant solution) to distribute the adjuvant in sprayed droplets of the first liquid so as to concentrate adjuvant within a partial volume near to the droplet surface (a “cloaking volume”), with lower adjuvant concentration in a bulk interior volume that includes the droplet center, wherein the contacting of the first liquid and the adjuvant occurs before contact of the droplets with the plant surfaces, and wherein the cloaking volume contains concentrated adjuvant for at least a time period up until the droplet strikes the plant surface.

In certain embodiments, the cloaking volume has a value in a range from about 0.05V to about 0.5V, (e.g., from about 0.1V to about 0.5V, e.g., from about 0.15V to about 0.3V, e.g., a cloaking volume of about 0.2V), where V is total droplet volume.

In certain embodiments, the cloaking volume has an adjuvant concentration in a range from about 1.5 C to about 15 C (e.g., from about 2.5 C to about 8 C, e.g., from about 3C to about 6 C, e.g., an adjuvant concentration of about 4 C), where 1 C is total amount of adjuvant (e.g., mass) divided by total droplet volume.

In certain embodiments, the cloaking volume contains concentrated adjuvant for at least a time period up until the droplet strikes the plant surface and rebounds.

In certain embodiments, the droplet rebounds without entirely leaving the plant surface.

In certain embodiments, the cloaking volume contains concentrated adjuvant for a time period of at least 20 ms, at least 50 ms, at least 100 ms, at least 150 ms, at least 200 ms, at least 250 ms, at least 500 ms, at least 1 s, at least 2 s, or longer.

In certain embodiments, the adjuvant comprises at least one member selected from the group consisting of a nonionic surfactant (NIS), a surfactant plus nitrogen source, an organo-silicone surfactant, a high surfactant oil concentrate (HSOC), a crop oil concentrate (COC), a vegetable oil concentrate, a modified vegetable oil (MVO or MSO), a nitrogen source, a deposition (drift control) and/or retention agent with or without ammonium sulfate and/or defoamer, a compatibility agent, a buffering agent and/or acidifier, a water conditioning agent, a basic blend, a sticker-spreader and/or extender, an adjuvant plus foliar fertilizer, an antifoam agent, a foam marker, a scent, and a tank cleaner and/or neutralizer (e.g., one or more adjuvants listed under the above-referenced categories in the Compendium of Herbicide Adjuvants, 2016, 13^{th} edition, the text of which is incorporated herein by reference in its entirety).

In certain embodiments, the first liquid is an agrochemical solution (e.g., an aqueous solution comprising an agrochemical), wherein the agrochemical comprises a pesticide (e.g., an insecticide, a herbicide, a rodenticide, and/or a fungicide).

In certain embodiments, the agrochemical comprises one or more members selected from the group consisting of glyphosate, imidacloprid, permethrin, pyrethrin, acetamiprid, organophosphate, acaricide, fibronil, 2,4-dichlorophoenoxyacetic acid, acephate, sulfur, cyhalothrin, copper sulfate, molluscicide, chlorpyrifos, malathion, carbaryl, boric acid, cypermethrin, bifenthrin, diazinon, and chlordane.

In certain embodiments, the first liquid is an agrochemical solution, wherein the agrochemical comprises a fertilizer.

In certain embodiments, the adjuvant is a non-oil adjuvant (e.g., a non-oil surfactant).

In certain embodiments, contacting the first liquid and the adjuvant comprises using a nozzle, wherein the nozzle comprises (i) a primary fluid inlet and channel for directing a first stream comprising the first liquid to a first nozzle outlet and (ii) a secondary fluid inlet and channel for directing a second stream comprising the adjuvant to a second nozzle outlet, said first nozzle outlet and second nozzle outlet positioned in relation to each other (e.g., at respective angles) to direct their respective streams to meet [e.g., for cloaking of droplets of the first liquid solution (e.g., water, agrochemical solution, or pesticide solution) with adjuvant solution].

In certain embodiments, the nozzle comprises a deflector plate to deflect fluid from the first stream exiting the first nozzle outlet and/or to deflect fluid from the second stream exiting the second nozzle outlet.

In certain embodiments, the deflector plate is located at or near the first nozzle outlet.

In certain embodiments, the deflector plate deflects the first stream and/or the second stream into a fan shape.

In certain embodiments, the nozzle comprises an elliptical orifice to create a fan of fluid (e.g., co-flowing fluid) that breaks up into droplets.

In certain embodiments, the elliptical orifice is located at or near the first nozzle outlet or the second nozzle outlet.

In certain embodiments, the second nozzle outlet comprises multiple orifices.

In certain embodiments, the second nozzle outlet comprises multiple orifices positioned on a common plane.

In certain embodiments, the second nozzle outlet comprises multiple orifices positioned on a plane at an acute angle (e.g., less than 90 degrees, e.g., between 20 and 80 degrees, e.g., between 30 and 70 degrees) with respect to a plane of the first nozzle outlet.

In certain embodiments, the first nozzle outlet comprises multiple orifices (e.g., multiple orifices positioned on a common plane, e.g., wherein the first nozzle outlet comprises multiple orifices positioned on a plane at an acute angle (e.g., less than 90 degrees, e.g., between 20 and 80 degrees, e.g., between 30 and 70 degrees) with respect to a plane of the second nozzle outlet).

In certain embodiments, the nozzle has a configuration depicted in FIG. 4, or any of FIGS. 7 to 23.

In another aspect, the invention is directed to a nozzle comprising (i) a primary fluid inlet and channel for directing a first stream (e.g., water or an aqueous solution, e.g., an agrochemical solution, e.g., a pesticide solution) to a first nozzle outlet and (ii) a secondary fluid inlet and channel for directing a second stream (e.g., adjuvant solution) to a second nozzle outlet, said first nozzle outlet and second nozzle outlet positioned in relation to each other (e.g., at respective angles) to direct their respective streams to meet [e.g., for cloaking of droplets of the aqueous solution (e.g., water, agrochemical solution, or pesticide solution) with adjuvant solution].

In certain embodiments, the nozzle comprises a deflector plate (e.g., located at or near the first nozzle outlet) to deflect fluid from the first stream exiting the first nozzle outlet (e.g., to deflect the first stream into a fan shape).

In certain embodiments, the nozzle comprises a deflector plate (e.g., located at or near the second nozzle outlet) to deflect fluid from the second stream exiting the second nozzle outlet (e.g., to deflect the second stream into a fan shape).

In certain embodiments, the second nozzle outlet comprises multiple orifices (e.g., multiple orifices positioned on a common plane, e.g., wherein the second nozzle outlet comprises multiple orifices positioned on a plane at an acute angle (e.g., less than 90 degrees, e.g., between 20 and 80 degrees, e.g., between 30 and 70 degrees) with respect to a plane of the first nozzle outlet).

In certain embodiments, the first nozzle outlet comprises multiple orifices (e.g., multiple orifices positioned on a common plane, e.g., wherein the first nozzle outlet comprises multiple orifices positioned on a plane at an acute angle (e.g., less than 90 degrees, e.g., between 20 and 80 degrees, e.g., between 30 and 70 degrees) with respect to a plane of the second nozzle outlet).

In certain embodiments, the nozzle has the configuration depicted in FIG. 4, or any of FIGS. 7 to 23.

In another aspect, the invention is directed to system for performing a method described herein, the system comprising:
one or more nozzles for creating droplets and/or directing the droplets onto the plant surfaces;
a first container (e.g., a first tank) for containing the first liquid (e.g., the agrochemical solution, e.g., the pesticide solution);
a second container (e.g., a second tank) for containing a second liquid comprising the adjuvant (e.g., an adjuvant solution);
a first pump for drawing the first liquid from the first container (e.g., through a first flow line, e.g., tubing or pipe) to at least a first nozzle; and
a second pump (e.g., dosing pump) for drawing the second liquid from the second container (e.g., through a second flow line, e.g., tubing or pipe) to at least the first nozzle,
wherein the one or more nozzles contact the first liquid and the adjuvant to distribute the adjuvant in sprayed droplets of the first liquid so as to concentrate adjuvant within a partial volume near to the droplet surface (a “cloaking volume”), with lower adjuvant concentration in a bulk interior volume that includes the droplet center, wherein the contacting of the first liquid and the adjuvant occurs before contact of the droplets with the plant surfaces, and wherein the cloaking volume contains concentrated adjuvant for at least a time period up until the droplet strikes the plant surface.

In certain embodiments, the second pump provides a lower flow rate of the second liquid than the first liquid.

In certain embodiments, the flow rate of the second liquid is less than 1% (e.g., less than 0.5%, e.g., about 0.25%) of the flow rate of the first liquid.

In certain embodiments, the one or more nozzles comprises a nozzle series.

In certain embodiments, the nozzle series comprises a line of spaced-apart nozzles positioned for application of sprayed liquid onto corresponding multiple rows of plants.

In certain embodiments, the system is a retrofit of an existing spraying system (e.g., an existing pesticide spraying system).

In certain embodiments, at least one of the one or more nozzles is a nozzle as described herein (e.g., depicted in FIG. 4, or any of FIGS. 7 to 23).

### BRIEF DESCRIPTION OF THE DRAWINGS

The foregoing and other objects, aspects, features, and advantages of the present disclosure will become more apparent and better understood by referring to the following description taken in conjunction with the accompanying drawings, in which:

FIG. 1 depicts two series of photographs comparing the behavior of an uncloaked adjuvant-containing droplet striking a plant surface with a cloaked adjuvant-containing droplet, according to an illustrative embodiment.

FIG. 2 is a schematic diagram illustrating the benefit of cloaking droplets with adjuvant, according to an illustrative embodiment.

FIG. 3 depicts three series of photographs comparing the behavior of droplets striking a plant surface at an angle, according to an illustrative embodiment. The cloaked droplet with 0.25% overall adjuvant concentration was retained on the plant surface (no rebound fully off the surface), similar to the uncloaked droplet with a much higher (1.25%) adjuvant concentration, unlike the uncloaked droplet with 0.25% overall adjuvant concentration, which rebounded fully off the plant surface.

FIG. 4 depicts a demonstration of a nozzle for creating cloaked droplets, where the nozzle has a first inlet for a first stream (e.g., water, e.g., an aqueous solution containing a pesticide) and a second inlet for a second stream (e.g., an aqueous solution containing an adjuvant), according to an illustrative embodiment.

FIG. 5 depicts a retrofit injection system comprising nozzles having a design shown in any of FIG. 4 or 7 to 23, according to an illustrative embodiment.

FIG. 6 is a graph depicting surface area fraction of a plant surface covered by liquid using (i) a conventional bulk deflector fan nozzle, (ii) a conventional bulk flat fan nozzle, and (iii) a cloaking deflector fan nozzle according to an illustrative embodiment.

FIG. 7 is a schematic drawing of a nozzle for creating cloaked droplets, according to an illustrative embodiment. FIG. 7 depicts a type of deflector nozzle where a jet of fluid hits a plate (e.g., a deflector plate) and the plate deflects the fluid into a fan shape, according to an illustrative embodiment.

FIG. 8 is a schematic drawing of a nozzle for creating cloaked droplets, according to an illustrative embodiment.

FIG. 9 is a schematic drawing of a nozzle for creating cloaked droplets, according to an illustrative embodiment.

FIG. 10 is a schematic drawing of a nozzle for creating cloaked droplets, according to an illustrative embodiment.

FIG. 11 is a schematic drawing of a nozzle for creating cloaked droplets, according to an illustrative embodiment.

FIG. 12 is a schematic drawing of a nozzle for creating cloaked droplets, according to an illustrative embodiment.

FIG. 13 is a schematic drawing of a nozzle for creating cloaked droplets, according to an illustrative embodiment. FIG. 13 depicts a deflector nozzle where a jet of fluid hits a plate (e.g., a deflector plate) and the plate deflects the fluid into a fan shape, according to an illustrative embodiment.

FIG. 14 is a schematic drawing of a nozzle for creating cloaked droplets, according to an illustrative embodiment.

FIG. 15 is a schematic drawing of a nozzle for creating cloaked droplets, according to an illustrative embodiment.

FIG. 16 is a schematic drawing of a flat fan cloaking nozzle where fluid is forced through an elliptical orifice to create a fan of co-flowing liquid that breaks up into droplets, according to an illustrative embodiment.

FIG. 17 is a schematic drawing of a nozzle for creating cloaked droplets, according to an illustrative embodiment.

FIG. 18 is a schematic drawing of a nozzle for creating cloaked droplets, according to an illustrative embodiment.

FIG. 19 is a schematic drawing of a nozzle for creating cloaked droplets, according to an illustrative embodiment.

FIG. 20 is a schematic drawing of a nozzle for creating cloaked droplets, according to an illustrative embodiment.

FIG. 21 is a schematic drawing of a nozzle for creating cloaked droplets, according to an illustrative embodiment.

FIG. 22 is a schematic drawing of a nozzle for creating cloaked droplets, according to an illustrative embodiment.

FIG. 23 shows a schematic drawing of a nozzle for creating cloaked droplets (FIG. 23, panel A) and a schematic drawing of a nozzle body (FIG. 23, panel B), according to an illustrative embodiment.

FIG. 24 depicts two sets of images comparing the behavior of an uncloaked adjuvant-containing droplet striking a plant surface (FIG. 24, panel A) with a cloaked adjuvant-containing droplet (FIG. 24, panel B), according to an illustrative embodiment.

FIG. 25 shows a surface being sprayed using conventional spray methods (left panel) as compared with a surface being sprayed according to devices and methods described herein (right panel), according to an illustrative embodiment.

FIG. 26 shows systems for laboratory simulations of devices and methods described herein, according to an illustrative embodiment.

FIG. 27 shows an exemplary nozzle for creating cloaked droplets.

FIG. 28 shows box plots of coverage over time with two different nozzle types, according to an illustrative embodiment.

FIG. 29 depicts an injection system comprising nozzles having a design shown in any of FIG. 4 or 7 to 23, according to an illustrative embodiment.

FIG. 30 depicts an injection system comprising nozzles (e.g., nozzles having a design as shown in any of FIG. 4 or 7 to 23), according to an illustrative embodiment.

FIG. 31 shows a series of images comparing coverage of leaves, according to an illustrative embodiment.

FIG. 32 shows a series of bar graphs comparing coverage using a method as described herein as compared with a control treatment method, according to an illustrative embodiment.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### CERTAIN DEFINITIONS

In order for the present disclosure to be more readily understood, certain terms are first defined below. Additional definitions for the following terms and other terms are set forth throughout the specification.

A, an: The articles “a” and “an” are used herein to refer to one or to more than one (i.e., at least one) of the grammatical object of the article. By way of example, “an element” means one element or more than one element. Thus, in this specification and the appended claims, the singular forms “a,” “an,” and “the” include plural references unless the context clearly dictates otherwise. Thus, for example, reference to an agrochemical solution comprising “an agrochemical” includes reference to two or more agrochemicals.

About, approximately: As used in this application, the terms “about” and “approximately” are used as equivalents. Any numerals used in this application with or without about/approximately are meant to cover any normal fluctuations appreciated by one of ordinary skill in the relevant art. In certain embodiments, the term “approximately” or “about” refers to a range of values that fall within 25%, 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value).

### DETAILED DESCRIPTION

It is contemplated that systems, architectures, devices, methods, and processes of the claimed invention encompass variations and adaptations developed using information from the embodiments described herein. Adaptation and/or modification of the systems, architectures, devices, methods, and processes described herein may be performed, as contemplated by this description.

Throughout the description, where articles, devices, systems, and architectures are described as having, including, or comprising specific components, or where processes and methods are described as having, including, or comprising specific steps, it is contemplated that, additionally, there are articles, devices, systems, and architectures of the present invention that consist essentially of, or consist of, the recited components, and that there are processes and methods according to the present invention that consist essentially of, or consist of, the recited processing steps.

It should be understood that the order of steps or order for performing certain action is immaterial so long as the invention remains operable. Moreover, two or more steps or actions may be conducted simultaneously.

The mention herein of any publication is not an admission that the publication serves as prior art with respect to any of the claims presented herein. The Background section may include concepts informed by the embodiments recited in the claims and further described elsewhere in the specification. The discussion of concepts in the Background section is not an admission that the subject matter discussed is prior art.

Documents are incorporated herein by reference as noted. Where there is any discrepancy in the meaning of a particular term, the meaning provided in this document is controlling.

Headers are provided for the convenience of the reader-the presence and/or placement of a header is not intended to limit the scope of the subject matter described herein.

Presented herein are systems, methods, and devices for enhancing coverage and retention of liquid solutions sprayed onto plant surfaces. More particularly, in certain embodiments, presented herein are systems, methods, and devices for distributing adjuvant in sprayed droplets to concentrate adjuvant within a partial volume near to the droplet surface (e.g., a “cloaking volume”), with lower adjuvant concentration in a bulk interior volume that includes the droplet center.

Additionally, presented herein are nozzles and spraying systems particularly well-suited for performing the improved cloaking technique. In certain embodiments, a nozzle comprises (i) a primary fluid inlet and channel for directing a first stream (e.g., water or an aqueous solution, e.g., an agrochemical solution, e.g., a pesticide solution) to a first nozzle outlet and (ii) a secondary fluid inlet and channel for directing a second stream (e.g., adjuvant solution) to a second nozzle outlet, said first nozzle outlet and second nozzle outlet positioned in relation to each other (e.g., at respective angles) to direct their respective streams to meet [e.g., for cloaking of droplets of the aqueous solution (e.g., water, agrochemical solution, or pesticide solution) with adjuvant solution]. In certain embodiments, a nozzle comprises a deflector plate (e.g., located at or near the first nozzle outlet) to deflect fluid from the first stream exiting the first nozzle outlet (e.g., to deflect the first stream into a fan shape). In certain embodiments, the nozzle comprises a deflector plate (e.g., located at or near the second nozzle outlet) to deflect fluid from the second stream exiting the second nozzle outlet (e.g., to deflect the second stream into a fan shape). In certain embodiments, the second nozzle outlet comprises multiple orifices (e.g., multiple orifices positioned on a common plane, e.g., wherein the second nozzle outlet comprises multiple orifices positioned on a plane at an acute angle (e.g., less than 90 degrees, e.g., between 20 and 80 degrees, e.g., between 30 and 70 degrees) with respect to a plane of the first nozzle outlet).

Various cloaking methods, compositions, and devices are described in U. S. Patent Application Publication No. US 2023/0135222, published May 4, 2023, “Compositions, Articles, Devices, and Methods Related to Droplets Comprising a Cloaking Fluid,” by Varanasi et al., filed Oct. 27, 2022, the text of which is incorporated herein by reference in its entirety.

### I. ADJUVANTS

As used herein, the term “adjuvant” can be used to describe a substance that alters the performance and/or properties of a desired chemical in a composition. In some embodiments, an adjuvant is a substance added to a tank mix to aid or modify an action of an agrochemical, or physical characteristics of a mixture. In some embodiments, an adjuvant is used to cloak droplets of an agrochemical solution in order to promote sticking of droplets (retention) on a plant surface. In some embodiments, adjuvants are designed and incorporated to perform functions related to mixing and application of agrochemicals including, but not limited to, dispersing, emulsifying, spreading, sticking, and wetting. In some embodiments, adjuvants can reduce evaporation, foaming, spray drift, and volatilization. In some embodiments, an adjuvant can be designed to perform multiple functions. In some embodiments, multiple adjuvants can be used together to achieve a particular desired result or set of results.

In some embodiments, an adjuvant is a nonionic surfactant (NIS), a surfactant plus nitrogen source, an organo-silicone surfactant, a high surfactant oil concentrate (HSOC), a crop oil concentrate (COC), a vegetable oil concentrate, a modified vegetable oil (MVO or MSO), a nitrogen source, a deposition (drift control) and/or retention agent with or without ammonium sulfate and/or defoamer, a compatibility agent, a buffering agent and/or acidifier, a water conditioning agent, a basic blend, a sticker-spreader and/or extender, an adjuvant plus foliar fertilizer, an antifoam agent, a foam marker, a scent, or a tank cleaner and/or neutralizer. In some embodiments, an adjuvant is an adjuvant as described in “Compendium of Herbicide Adjuvants,” 2016, 13^{th} edition, Young, Matthews, and Whitford, Purdue University, Southern Illinois University, and Purdue Pesticide Programs, which is incorporated by reference in its entirety.

In some embodiments, an adjuvant is a non-oil adjuvant (e.g., a non-oil surfactant). Solutions containing non-oil adjuvants are found to work well with cloaking methods described herein.

In certain embodiments, a cloaking volume has an adjuvant concentration in a range from about 2.5 C to about 8 C (e.g., from about 3 C to about 6 C, e.g., an adjuvant concentration of about 4 C), where 1 C is total amount of adjuvant (e.g., mass) divided by total droplet volume.

### II. AGROCHEMICALS

As used herein, an agrochemical (agricultural chemical) refers to a chemical product used in agriculture. In certain embodiments, an agrochemical solution contains one or more agrochemicals as described herein.

In some embodiments, an agrochemical is a biocide or a pesticide. For example, an agrochemical can be an insecticide, a herbicide, a rodenticide, and/or a fungicide. Exemplary agrochemicals include, but are not limited to, glyphosate, imidacloprid, permethrin, pyrethrin, acetamiprid, organophosphate, acaricide, fibronil, 2,4-dichlorophoenoxyacetic acid, acephate, sulfur, cyhalothrin, copper sulfate, molluscicide, chlorpyrifos, malathion, carbaryl, boric acid, cypermethrin, bifenthrin, diazinon, and chlordane.

In some embodiments, an agrochemical is a fertilizer (e.g., a foliar fertilizer).

In some embodiments, agrochemicals are used as or are part of formulations for providing nutrients to or replenishing nutrients of plants (e.g., nutrient formulations).

### III. EXAMPLES

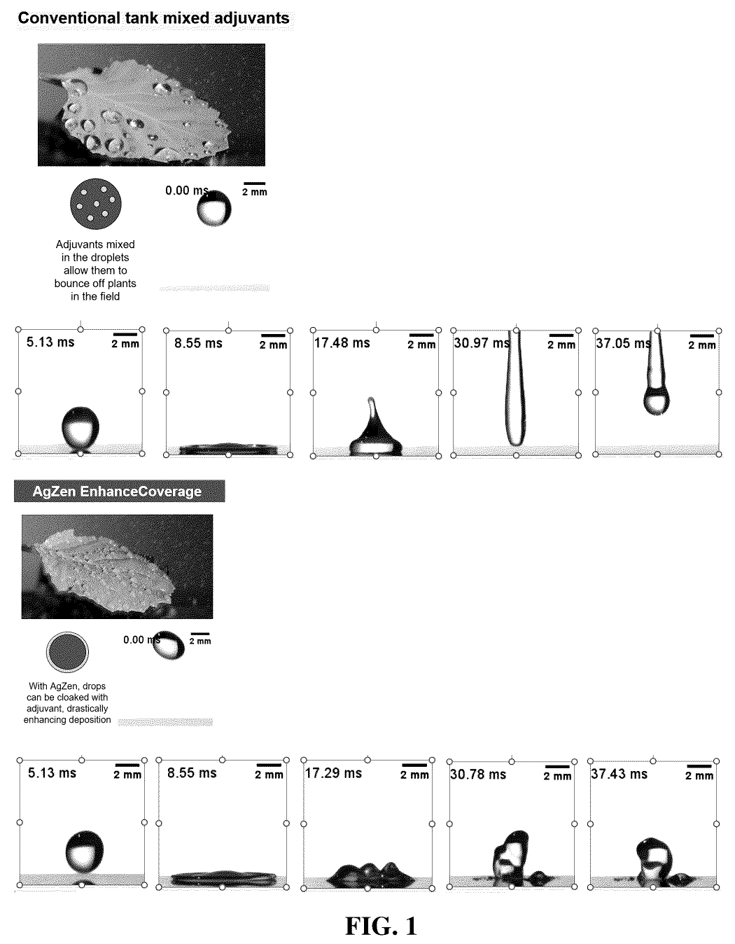

FIG. 1 depicts two series of photographs comparing the behavior of an uncloaked adjuvant-containing droplet striking a plant surface with a cloaked adjuvant-containing droplet. The top series depicts stills from high-speed video of droplets of conventional tank-mixed adjuvant solutions, wherein the droplets have a relatively homogenous concentration of adjuvant throughout the volume of the droplet. In the time series depicted, the droplet strikes the plant surface at about 5.13 ms, flattens at about 8.55 ms, rebounds at about 17.48 ms, begins complete separation from the plant surface at about 30.97 ms, and continues off the plant surface at 37.05 ms.

The bottom series depicts stills from high-speed video of droplets containing the same overall amount of adjuvant as in the first series of stills (the conventional tank-mixed adjuvant), except the droplets in the bottom series are cloaked with adjuvant according to devices and methods described herein. As seen in the bottom series of high-speed video stills captured at approximately the same times as above, the droplet strikes the plant surface, flattens, and rebounds but does not separate from the plant surface at any point. The droplet is retained on the plant surface.

In certain embodiments, the cloaking volume of the droplet in the bottom series shown in FIG. 1 has a value in a range from about 0.1V to about 0.5V (e.g., from about 0.15V to about 0.3V, e.g., a cloaking volume of about 0.2V), where V is total droplet volume. In certain embodiments, the cloaking volume has an adjuvant concentration in a range from about 2.5 C to about 8 C (e.g., from about 3 C to about 6 C, e.g., an adjuvant concentration of about 4 C), where 1 C is total amount of adjuvant (e.g., mass) divided by total droplet volume. Thus, the same overall amount of adjuvant can be used in the same volume of liquid, but can be distributed in the droplets in a way that maximizes the surface-sticking properties contributed by the adjuvant.

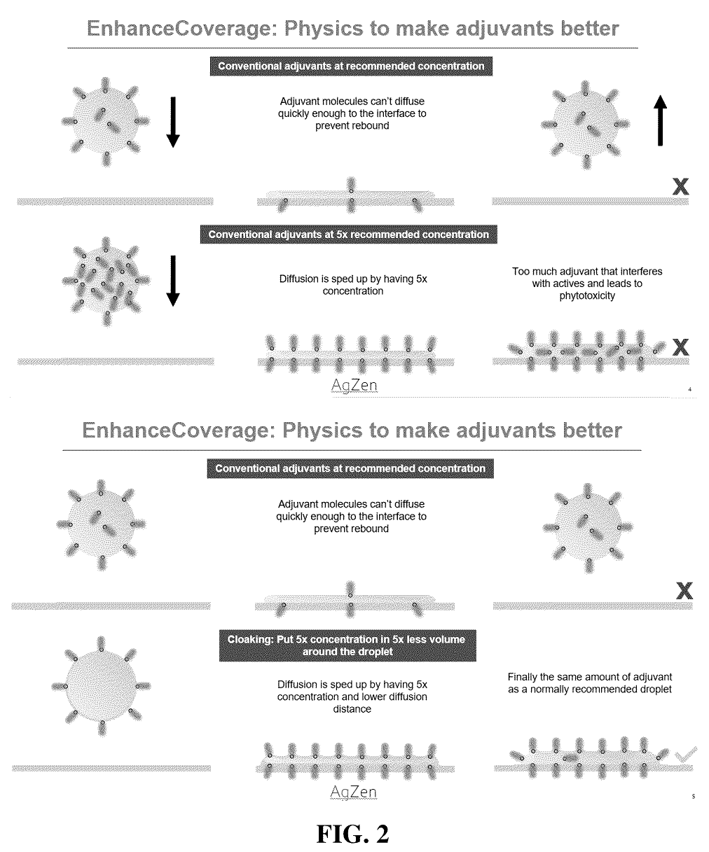

FIG. 2 is a schematic diagram illustrating the benefit of cloaking droplets of an agrochemical solution (e.g., a pesticide solution) with adjuvant in order to promote sticking of droplets (retention) on a plant surface.

The top diagram of FIG. 2 illustrates two droplets striking the plant surface—the first droplet having a lower adjuvant concentration and the second droplet having a higher adjuvant concentration, with adjuvant molecules depicted as small capsules in and about the droplet. For both droplets pictured in the top diagram of FIG. 2, the adjuvant is added via conventional means, for example, by mixing of adjuvant into the solution in a tank prior to formation of droplets. At low concentration (first droplet), the adjuvant molecules cannot diffuse quickly enough to the droplet/plant surface interface to prevent rebound (shown at right). At high concentration (second droplet), diffusion is effectively sped up (there is a higher density of adjuvant molecules at the surface) due to higher concentration of adjuvant in the droplet—here, 5× the concentration as in the first droplet—and, as a result, the second droplet does not rebound (shown at right) and is retained on the plant surface. However, using more than the recommended amount of adjuvant can interfere with active ingredients of the agrochemical solution in which the adjuvant is mixed, and may lead to phytotoxicity.

The bottom diagram of FIG. 2 also illustrates two droplets striking the plant surface. However, the first and second droplet of the bottom diagram have the same overall adjuvant concentration (amount of adjuvant per droplet volume). Here, the first droplet has a relatively homogeneous concentration of adjuvant in the volume, having been made by conventional means. By contrast, the second droplet is a cloaked droplet that has a heterogeneous adjuvant concentration profile with most (if not all) of the adjuvant located in a small volume (cloak) about/near the exterior of the droplet. A cloaked droplet may be created using the techniques described herein. Even though the first and second droplets of the bottom diagram of FIG. 2 have the same overall amount of adjuvant per droplet volume, the first droplet rebounds while the second droplet sticks to the plant surface. Without wishing to be bound to any particular theory, it is believed that the first droplet rebounds because its adjuvant molecules cannot diffuse quickly enough to the droplet/plant surface interface (and/or the adjuvant molecules cannot achieve sufficiently high molecular density at the interface) in the time frame necessary to prevent droplet rebound, whereas the second droplet sticks to the plant surface, since diffusion is effectively sped up (with lower average diffusion distance) by having a higher concentration of adjuvant near the exterior of the droplet (and/or the adjuvant molecules can maintain sufficiently high molecular density at the interface) in the time frame necessary to prevent rebound.

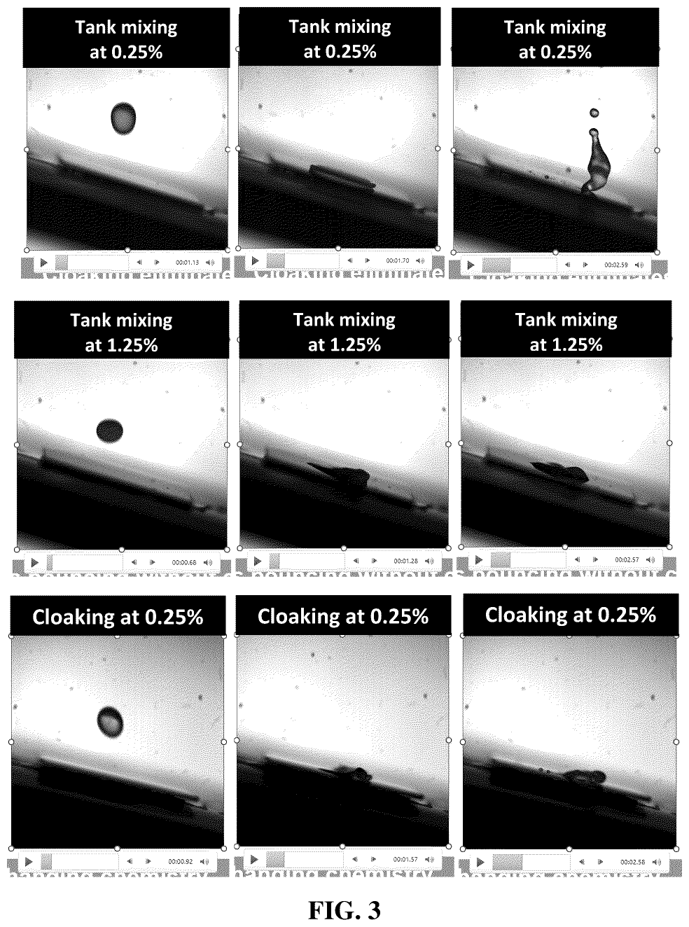

FIG. 3 depicts three series of photographs comparing the behavior of droplets striking a plant surface at an angle, according to an illustrative embodiment. The top series of three photograph represents a conventionally tank-mixed droplet with 0.25% adjuvant solution at low adjuvant concentration (0.25%, wt. %), with adjuvant concentration relatively homogenous throughout the droplet. The middle series of three photographs represents a conventionally tank-mixed droplet, but with high adjuvant concentration (1.25%). The bottom series of three photographs represents a droplet that is cloaked using the methods described herein, with low overall adjuvant concentration (0.25%), but with high adjuvant concentration within the “cloak” volume near the droplet surface. The cloaked droplet with 0.25% overall adjuvant concentration was retained on the plant surface (no rebound fully off the surface), similar to the uncloaked droplet with a much higher (1.25%) adjuvant concentration, and unlike the uncloaked droplet with 0.25% overall adjuvant concentration, which rebounded fully off the plant surface. Thus, it is possible to use a lower adjuvant concentration to achieve sticking of droplets to plant surfaces while still avoiding problems such as phytotoxicity caused by use of larger amounts of adjuvant. There are also cost savings and potential pollution prevention that results from use of the cloaking technique.

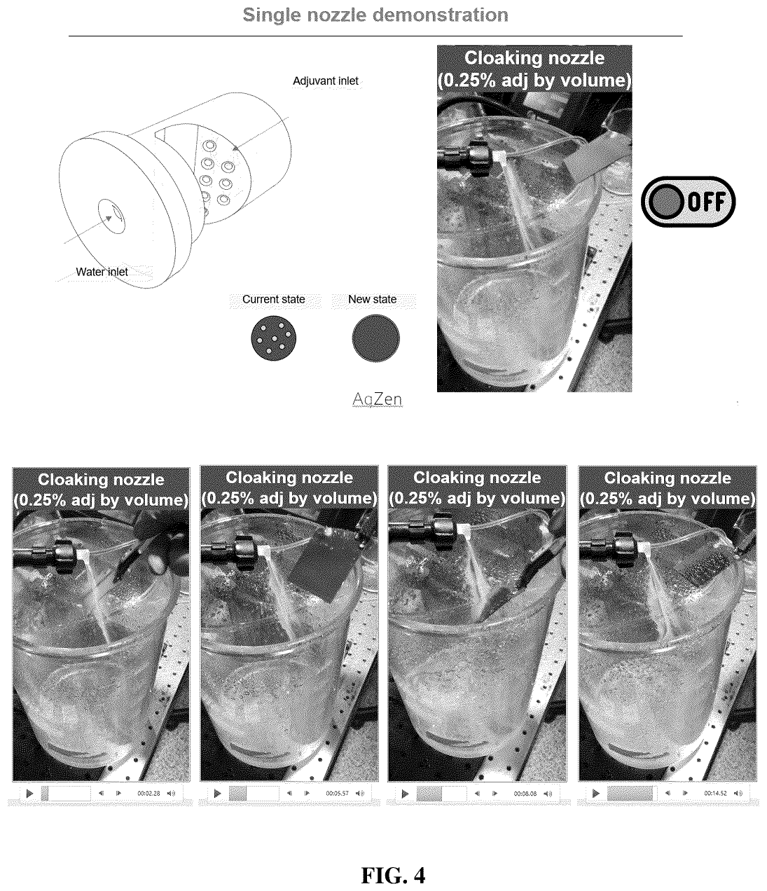

FIG. 4 depicts a demonstration of a nozzle for creating cloaked droplets, where the cloaking nozzle has a first inlet (e.g., a primary fluid inlet) for a first stream (e.g., water, e.g., an aqueous solution containing a pesticide) and a second inlet (e.g., a secondary fluid inlet) for a second stream (e.g., an aqueous solution containing an adjuvant), as depicted in the schematic drawing at upper left. This nozzle has a second nozzle outlet that comprises multiple orifices (e.g., multiple orifices positioned on a common plane, e.g., wherein the second nozzle outlet comprises multiple orifices positioned on a plane at an acute angle (e.g., less than 90 degrees, e.g., between 20 and 80 degrees, e.g., between 30 and 70 degrees) with respect to a plane of the first nozzle outlet).

Time series photos of a procedure to demonstrate use of the cloaking nozzle are also shown in FIG. 4. The first photo (top) shows a metal surface held at the side of a glass with only water flowing through the cloaking nozzle, with a stream of water being pumped through the first inlet of the nozzle, through the first channel of the nozzle, and out the first outlet of the nozzle, thereby creating droplets. In this photo, there is no adjuvant being introduced via the adjuvant inlet (second inlet of the nozzle). The first photo of the bottom row shows the metal surface being held at an angle under the stream of droplets with no adjuvant solution being used. The second photo shows that none of the droplets stuck to the metal surface.

Next, a stream of an adjuvant solution was pumped through the second inlet (the “adjuvant inlet”) of the nozzle, through the adjuvant channel, and out the adjuvant orifices of the nozzle, where the adjuvant comes into contact with water droplets coming out of the first inlet of the nozzle, thereby forming a cloak of adjuvant about the water droplets. The third photo of the bottom row shows the same metal surface being held at approximately the same angle under the stream of cloaked droplets. The fourth photo of the bottom row shows that the cloaked droplets stuck to the metal surface.

One of skill in the art may adjust flow rates of the respective solutions to optimize cloaking of droplets for a particular situation.

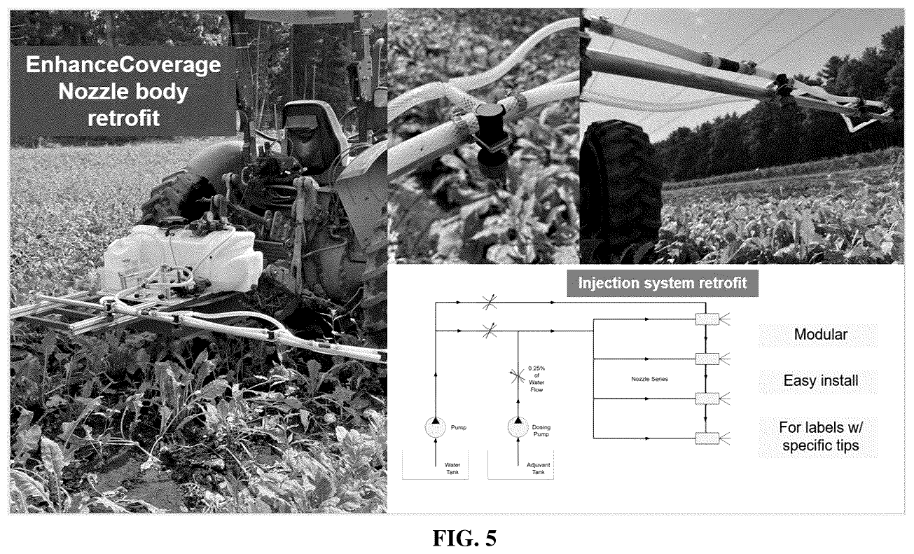

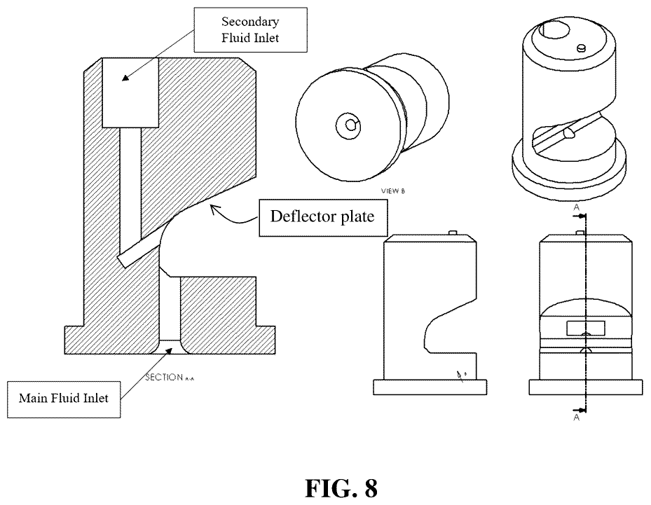

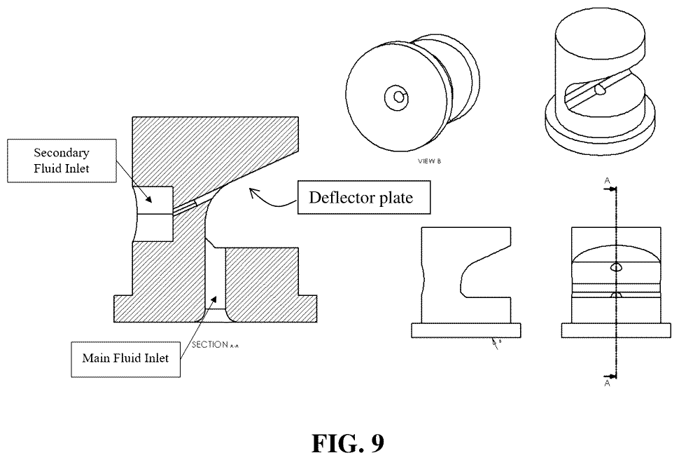

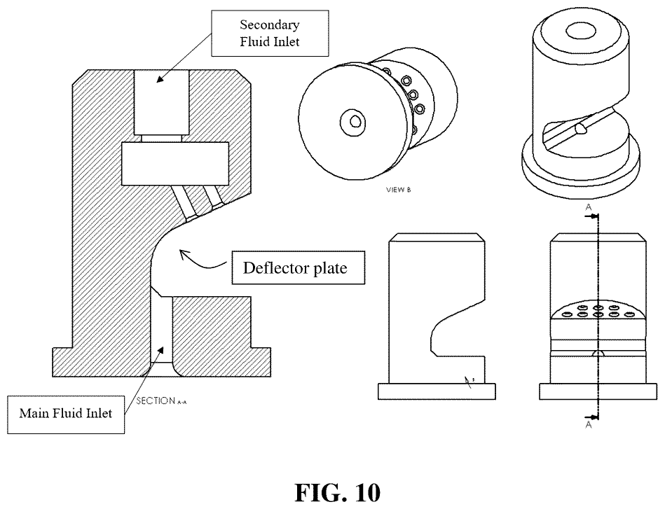

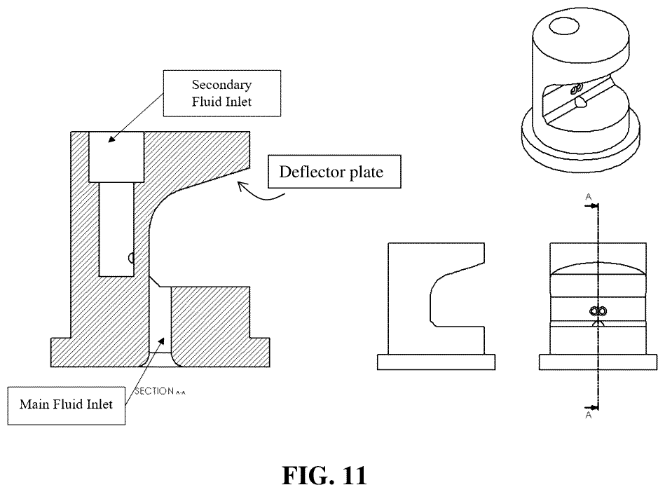

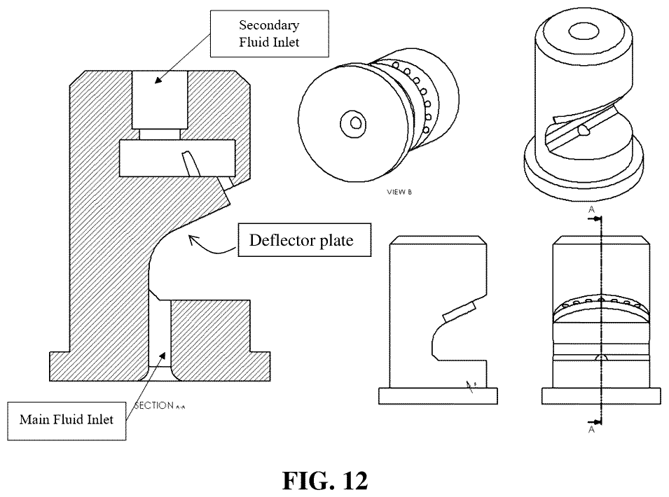

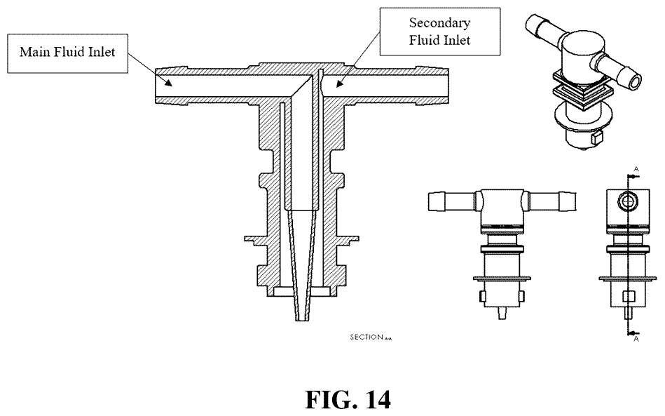

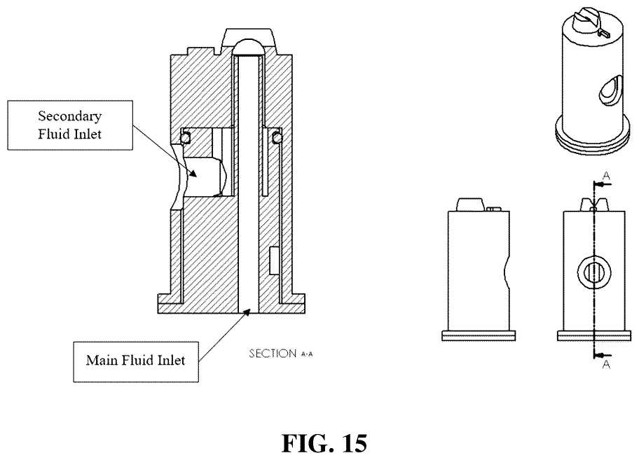

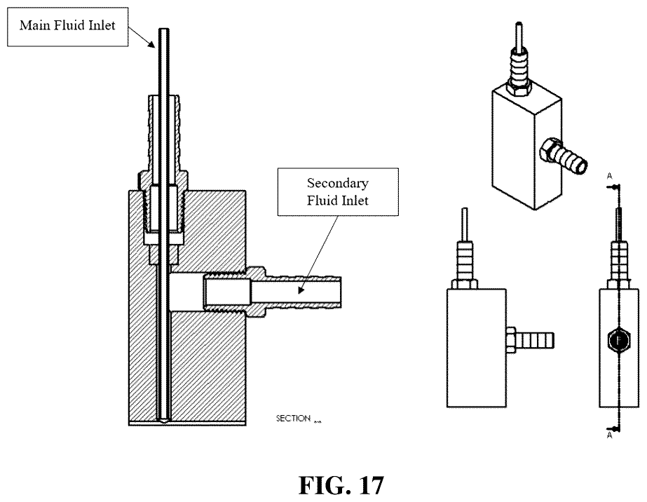

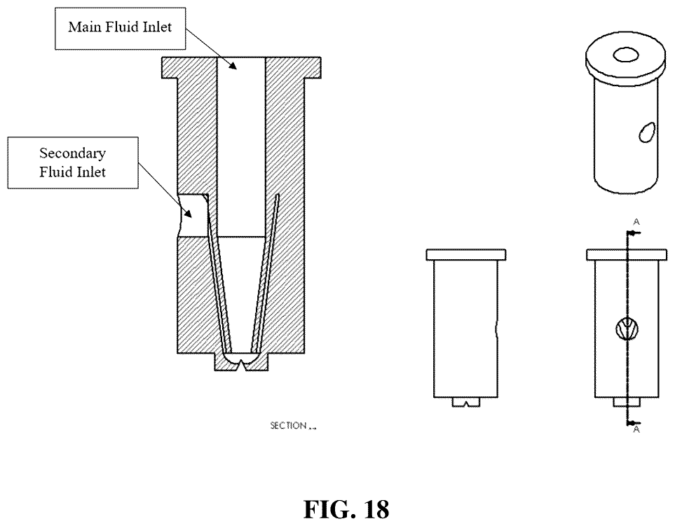

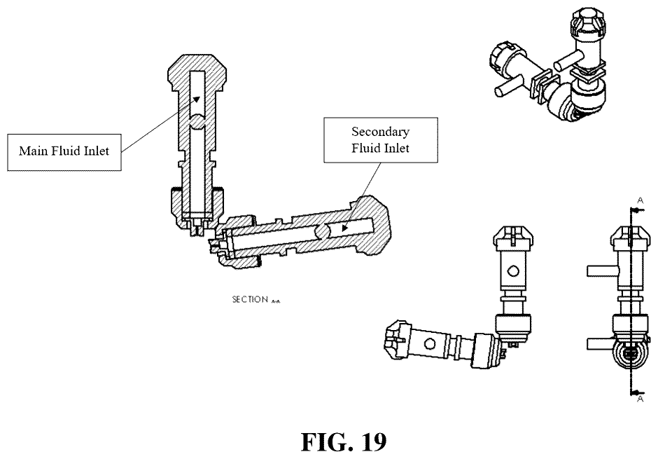

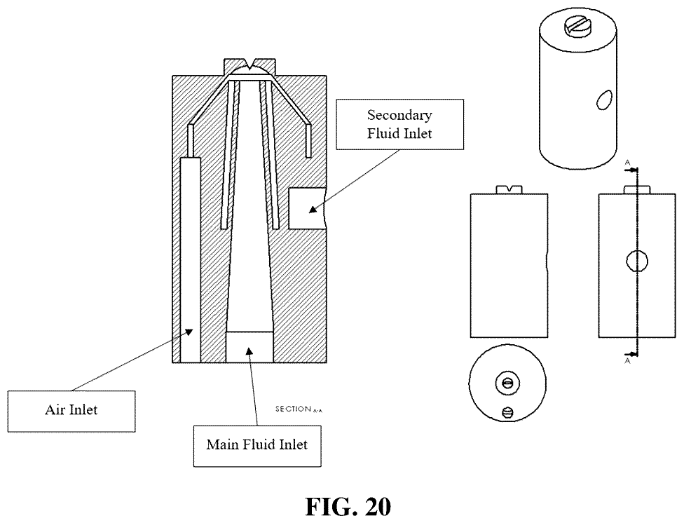

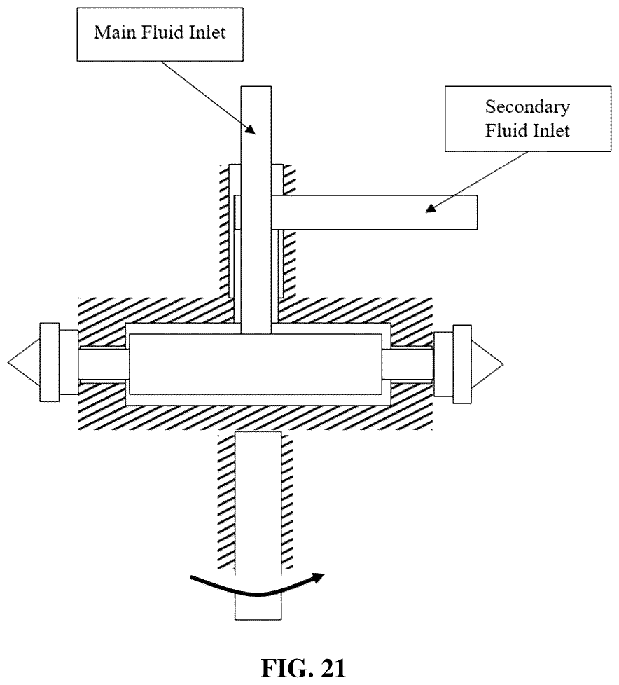

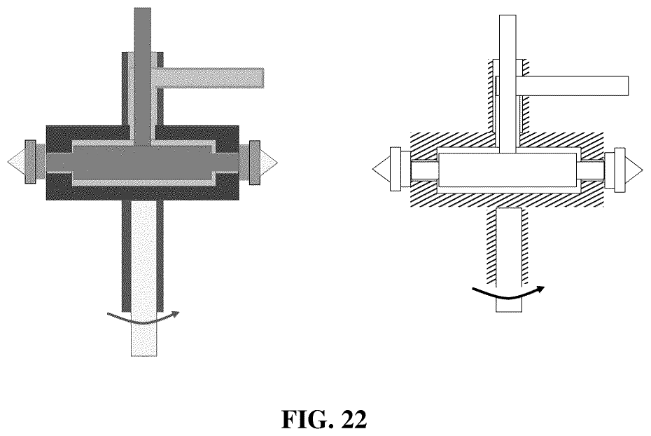

FIG. 5 depicts a retrofit injection system comprising nozzles having a design shown in any of FIG. 4 or 7 to 23, according to an illustrative embodiment. In this example, the system has a first container (e.g., a water tank) for containing a first liquid (e.g., water or an aqueous agrochemical solution, e.g., a pesticide solution); a second container (e.g., an adjuvant tank) for containing an adjuvant solution; a pump for drawing the first liquid from the first container through a flow line to a series of nozzles; and a dosing pump for drawing the adjuvant solution from the adjuvant tank through another flow line leading to the series of nozzles. In certain embodiments, the flow rate of the adjuvant solution is less than 1% (e.g., less than 0.5%, e.g., about 0.25%) the flow rate of the first liquid. As discussed above, each nozzle creates droplets via a first outlet (or first series of outlets) and brings the adjuvant solution into contact with those droplets (e.g., via a second outlet or second series of outlets). In certain embodiments, as pictured in FIG. 5, the nozzle series is a line of spaced-apart nozzles positioned for application of sprayed liquid onto corresponding multiple rows of plants. As shown in FIG. 5, this system can be part of (or attached to) a tractor designed to move down rows of plants (e.g., crops) for application of the first liquid cloaked with adjuvant. In certain embodiments, this is a retrofit of an existing spraying system, e.g., an existing pesticide spraying system.

As understood by one of skill in the art, the nozzle dimensions, including outlet and inlet sizes, and other dimensions of the system, can be optimized for a particular situation.

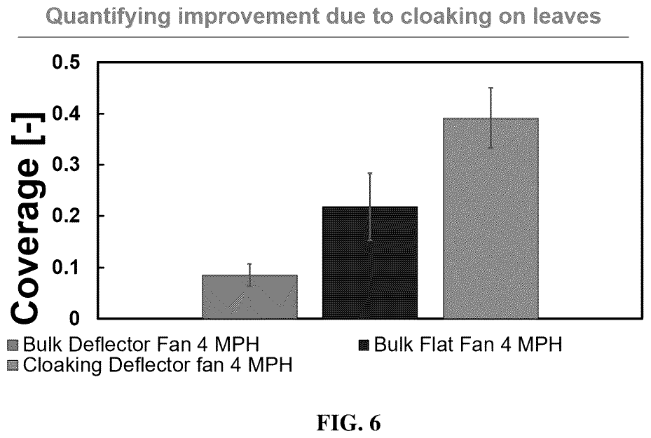

FIG. 6 is a graph depicting surface area fraction of a plant surface covered by liquid (“Coverage”) using an injection system such as depicted in FIG. 5 with (i) a conventional bulk deflector fan nozzle, (ii) a conventional bulk flat fan nozzle, and (iii) a cloaking deflector fan nozzle according to an illustrative embodiment. The conventional nozzles (i) and (ii) do not have a secondary flow inlet. In each case, the system was attached to a tractor moving at 4 mph with the nozzles positioned over rows of plant surfaces. The cloaking technique (iii) using a cloaking deflector fan nozzle resulted in a higher liquid coverage value than either of the conventional (non-cloaked) techniques (i) and (ii).

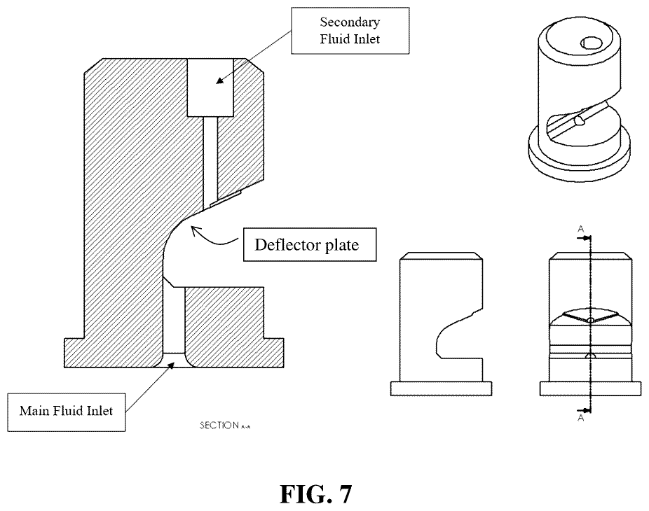

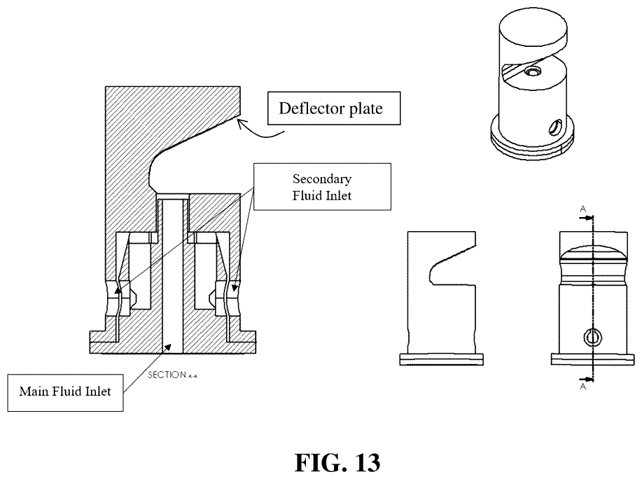

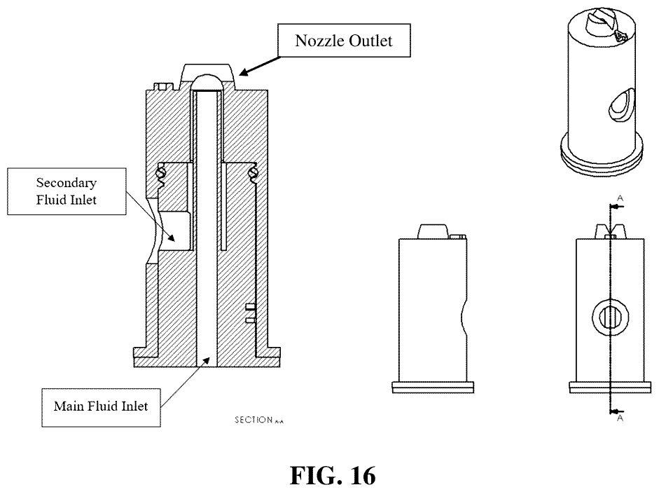

FIGS. 7 to 23 are schematic drawings of nozzles for creating cloaked droplets, said cloaking nozzles having various designs, according to illustrative embodiments. Of particular note, FIG. 7 and FIG. 13 depict two types of deflector nozzles where a jet of fluid hits a plate (e.g., a deflector plate) and the plate deflects the fluid into a fan shape, according to illustrative embodiments. FIG. 16 depicts a flat fan cloaking nozzle where fluid is forced through an elliptical orifice near the nozzle outlet to create a fan of co-flowing liquid that breaks up into droplets, according to an illustrative embodiment.

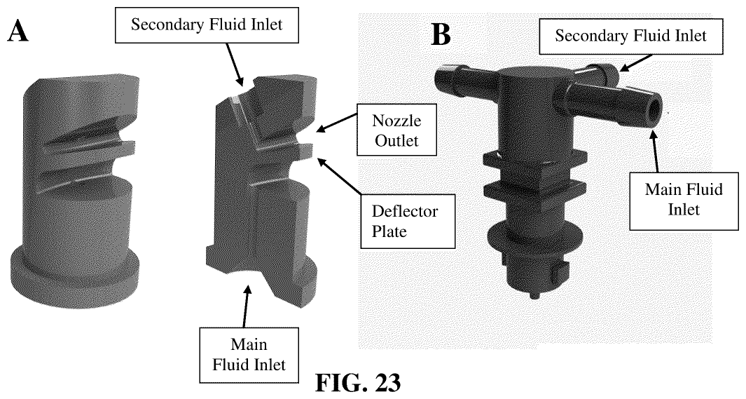

FIG. 23 shows a schematic drawing of a nozzle for creating cloaked droplets (panel A) and a schematic drawing of a nozzle body (panel B), according to an illustrative embodiment. The nozzle shown in the panel A of FIG. 23 has a plate (e.g., a deflector plate) for deflecting a jet of fluid into a fan shape located between the outlets of the adjuvant and main fluid streams, where the plate disperses the flow outward from the nozzle such that fluid (e.g., droplets) from both streams mix. As depicted in the figure, in certain embodiments, the dispersing surface is built into the body of the nozzle assembly such that it is not a separate component from the adjuvant flow channel and the main flow channel of the nozzle.

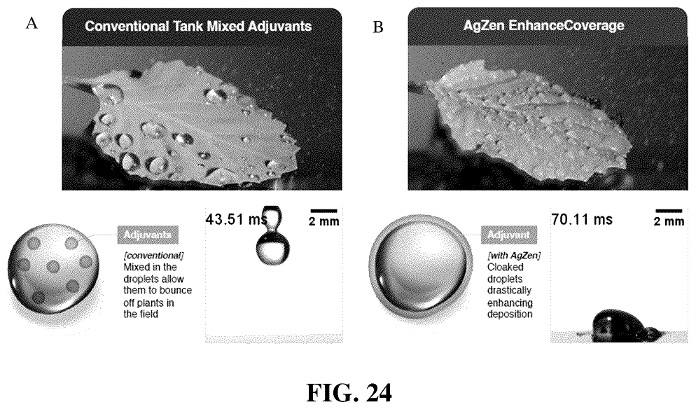

FIG. 24 panels A and B depict two panels comparing the behavior of an uncloaked adjuvant-containing droplet striking a plant surface with a cloaked adjuvant-containing droplet, according to an illustrative embodiment. In FIG. 24 panel A, the bottom right image depicts a still from a video of a droplet of conventional tank-mixed adjuvant solution, wherein the droplet has a relatively homogenous concentration of adjuvant throughout the volume of the droplet. In FIG. 24 panel A, the top image shows a leaf coated with droplets prepared using a conventional tank-based solution. In FIG. 24 panel B, the bottom right image depicts a still from a video of a droplet containing adjuvant as in FIG. 24 panel A, except the droplet in the bottom right image video still and droplets on the leaf are cloaked with adjuvant according to devices and methods described herein.

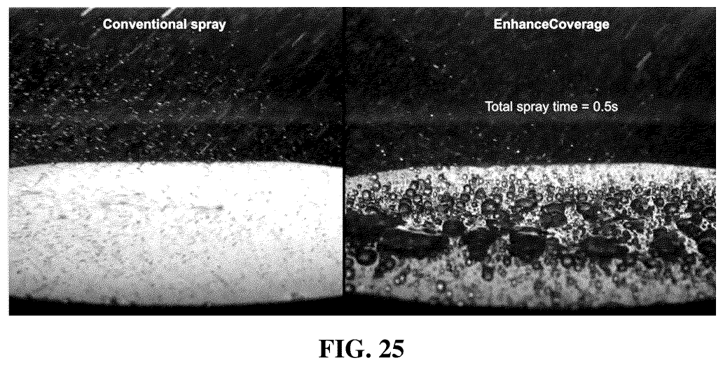

FIG. 25 shows a surface being sprayed using conventional spray methods (left panel) as compared with a surface being sprayed according to devices and methods described herein (right panel), according to an illustrative embodiment.

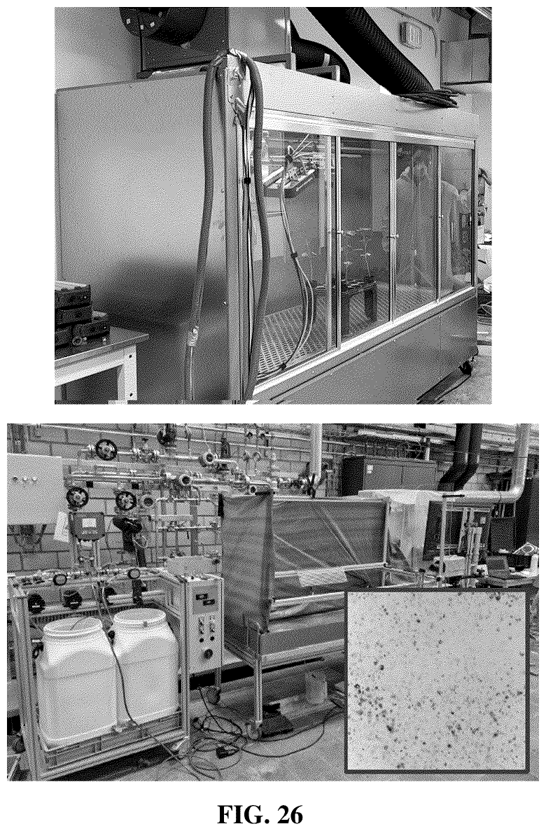

FIG. 26 shows systems for laboratory simulations of devices and methods described herein, according to an illustrative embodiment. Among other things, laboratory setups can be used to perform droplet size and fan shape analyses. In certain embodiments, the systems can be used to test various speeds (e.g., high speeds), dyes, and complex PDA. In certain embodiments, the systems can be used to test coverage of surfaces (e.g., plant surfaces) at varying speeds from 0 to 18 mph. In certain embodiments, the systems can be used to test wind and chemistry (e.g., adjuvant chemistry, agrochemicals).

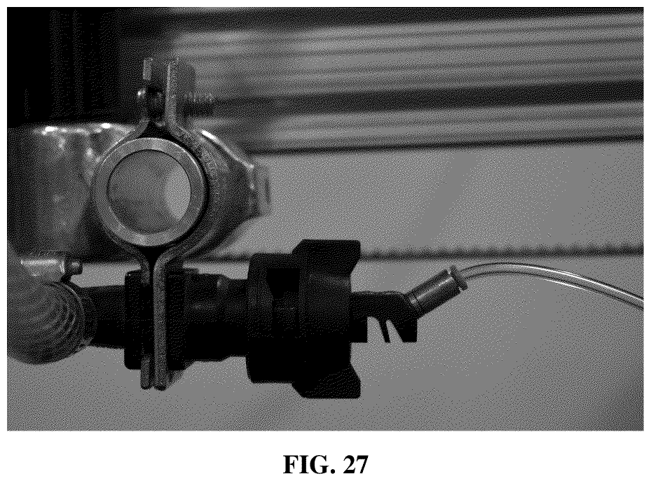

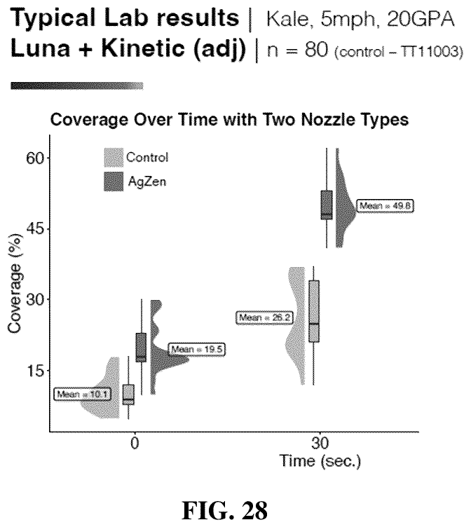

FIG. 27 shows an exemplary nozzle for creating cloaked droplets (e.g., a nozzle as shown in FIG. 23, panel A). Laboratory testing was used to validate tested nozzles for fan quality (e.g., quality of the fan of spray produced by a cloaking nozzle), shape, and aging. In certain embodiments, 80 degree, 110 degree, and 140 degree nozzle tips are used and can be tested using the depicted setup. FIG. 28 shows box plots of coverage over time with two different nozzle types, according to an illustrative embodiment. Among other things, the results demonstrate that, in certain embodiments, methods and devices described herein can provide more coverage over time (e.g., about 100% more coverage) as compared with a control setup while using the same GPM and adjuvant concentration.

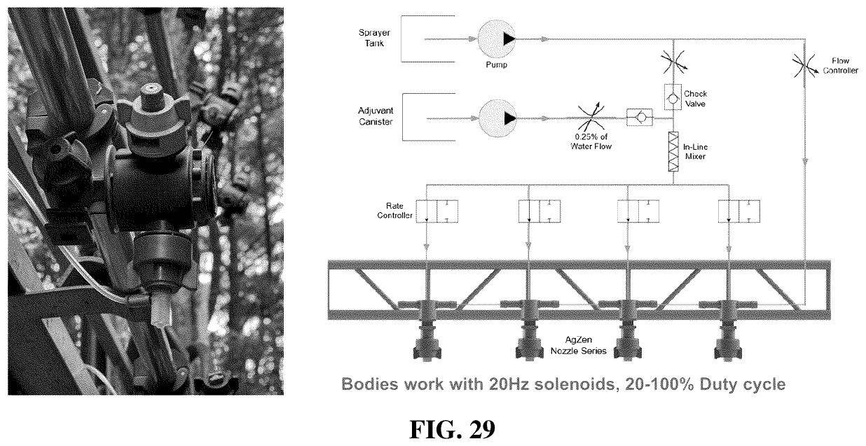

FIG. 29 depicts an injection system (e.g., a retrofit injection system) comprising nozzles having a design shown in any of FIG. 4 or 7 to 23, according to an illustrative embodiment. In this example, the system has a sprayer tank for containing a first liquid; an adjuvant tank for containing an adjuvant solution; a pump (e.g., a dosing pump) for drawing the first liquid from the sprayer tank through a flow line to a series of nozzles; and a pump (e.g., a dosing pump) for drawing the adjuvant solution from the adjuvant tank through another flow line leading to the series of nozzles. In certain embodiments, the flow rate of the adjuvant solution is less than 1% (e.g., less than 0.5%, e.g., about 0.25%) the flow rate of the first liquid. As discussed above, each nozzle creates droplets via a first outlet (or first series of outlets) and brings the adjuvant solution into contact with those droplets (e.g., via a second outlet or second series of outlets). In certain embodiments, as pictured in FIG. 29, the nozzle series is a line of spaced-apart nozzles positioned for application of sprayed liquid onto corresponding multiple rows of plants. In certain embodiments, this system can be part of (or attached to) a tractor designed to move down rows of plants (e.g., crops) for application of the first liquid cloaked with adjuvant. In certain embodiments, this is a retrofit of an existing spraying system, e.g., an existing pesticide spraying system. The left panel of FIG. 29 shows an illustrative nozzle assembly attached to a frame (e.g., a frame which can be attached to a tractor).

As understood by one of skill in the art, the nozzle dimensions, including outlet and inlet sizes, and other dimensions of the system, can be optimized for a particular situation.

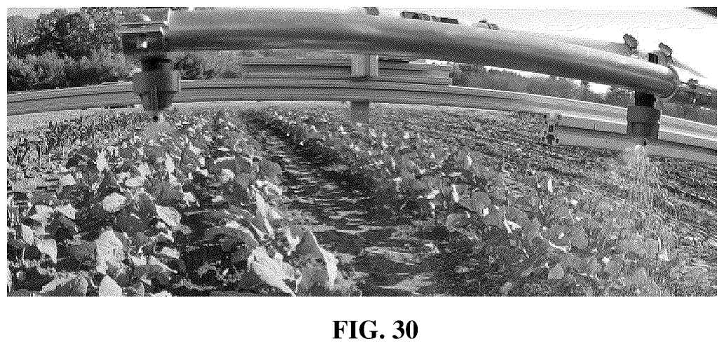

FIG. 30 depicts an injection system comprising nozzles (e.g., nozzles having a design as shown in any of FIG. 4 or 7 to 23), according to an illustrative embodiment.

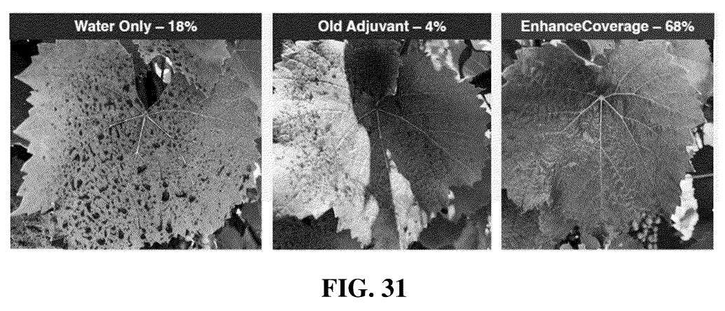

FIG. 31 shows a series of images comparing coverage of leaves with water only (18% coverage), an old adjuvant (4% coverage), and an adjuvant applied using methods and systems described herein, according to an illustrative embodiment.

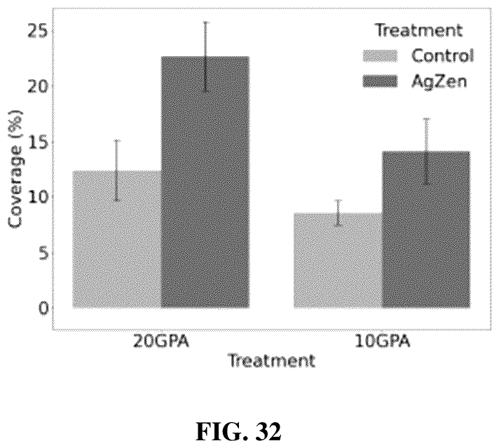

FIG. 32 shows a series of bar graphs comparing coverage using a method as described herein (e.g., an “AgZen method”) (e.g., methods and systems corresponding to FIGS. 30 and 31) as compared with a control treatment method, according to an illustrative embodiment. The bar graphs show that the method (e.g., the “AgZen method”) has greater coverage as compared to the control method when using either the 20 GPA treatment or 10 GPA treatment.

### OTHER EMBODIMENTS

While we have described a number of embodiments, it is apparent that our basic disclosure and examples may provide other embodiments that utilize or are encompassed by the compositions and methods described herein. Therefore, it will be appreciated that the scope of is to be defined by that which may be understood from the disclosure and the appended claims rather than by the specific embodiments that have been represented by way of example. All references cited herein are hereby incorporated by reference.

1. A method of applying a solution to plant surfaces, the method comprising contacting a first liquid and an adjuvant to distribute the adjuvant in sprayed droplets of the first liquid so as to concentrate adjuvant within a partial volume near to the droplet surface (a “cloaking volume”), with lower adjuvant concentration in a bulk interior volume that includes the droplet center, wherein the contacting of the first liquid and the adjuvant occurs before contact of the droplets with the plant surfaces, and wherein the cloaking volume contains concentrated adjuvant for at least a time period up until the droplet strikes the plant surface.

2. The method of claim 1, wherein the cloaking volume has a value in a range from about 0.05V to about 0.5V, where V is total droplet volume.

3. The method of claim 1, wherein the cloaking volume has an adjuvant concentration in a range from about 1.5 C to about 15 C, where 1 C is total amount of adjuvant divided by total droplet volume.

4-5. (canceled)

6. The method of claim 1, wherein the cloaking volume contains concentrated adjuvant for a time period of at least 20 ms, at least 50 ms, at least 100 ms, at least 150 ms, at least 200 ms, at least 250 ms, at least 500 ms, at least 1 s, at least 2 s, or longer.

7. The method of claim 1, wherein the adjuvant comprises at least one member selected from the group consisting of a nonionic surfactant (NIS), a surfactant plus nitrogen source, an organo-silicone surfactant, a high surfactant oil concentrate (HSOC), a crop oil concentrate (COC), a vegetable oil concentrate, a modified vegetable oil (MVO or MSO), a nitrogen source, a deposition (drift control) and/or retention agent with or without ammonium sulfate and/or defoamer, a compatibility agent, a buffering agent and/or acidifier, a water conditioning agent, a basic blend, a sticker-spreader and/or extender, an adjuvant plus foliar fertilizer, an antifoam agent, a foam marker, a scent, and a tank cleaner and/or neutralizer.

8. The method of claim 1, wherein the first liquid is an agrochemical solution, wherein the agrochemical comprises at least one of a pesticide and a fertilizer.

9. The method of claim 8, wherein the agrochemical comprises one or more members selected from the group consisting of glyphosate, imidacloprid, permethrin, pyrethrin, acetamiprid, organophosphate, acaricide, fibronil, 2,4-dichlorophoenoxyacetic acid, acephate, sulfur, cyhalothrin, copper sulfate, molluscicide, chlorpyrifos, malathion, carbaryl, boric acid, cypermethrin, bifenthrin, diazinon, and chlordane.

10. (canceled)

11. The method of claim 1, wherein the adjuvant is a non-oil adjuvant.

12. The method of claim 1, wherein contacting the first liquid and the adjuvant comprises using a nozzle, wherein the nozzle comprises (i) a primary fluid inlet and channel for directing a first stream comprising the first liquid to a first nozzle outlet and (ii) a secondary fluid inlet and channel for directing a second stream comprising the adjuvant to a second nozzle outlet, said first nozzle outlet and second nozzle outlet positioned in relation to each other to direct their respective streams to meet.

13. The method of claim 12, wherein the nozzle comprises a deflector plate to deflect fluid from the first stream exiting the first nozzle outlet and/or to deflect fluid from the second stream exiting the second nozzle outlet.

14. (canceled)

15. The method of claim 13, wherein the deflector plate deflects the first stream and/or the second stream into a fan shape.

16. The method of claim 12, wherein the nozzle comprises an elliptical orifice to create a fan of fluid that breaks up into droplets.

17. (canceled)

18. The method of claim 12, wherein at least one of the first nozzle outlet and the second nozzle outlet comprises multiple orifices.

19. The method of claim 18, wherein the second nozzle outlet comprises multiple orifices positioned on a common plane.

20. The method of claim 18, wherein the second nozzle outlet comprises multiple orifices positioned on a plane at an acute angle with respect to a plane of the first nozzle outlet.

21-22. (canceled)

23. A nozzle comprising (i) a primary fluid inlet and channel for directing a first stream to a first nozzle outlet and (ii) a secondary fluid inlet and channel for directing a second stream to a second nozzle outlet, said first nozzle outlet and second nozzle outlet positioned in relation to each other to direct their respective streams to meet.

24. The nozzle of claim 23, wherein the nozzle comprises a deflector plate to deflect fluid from the first stream exiting the first nozzle outlet.

25. The nozzle of claim 23, wherein the nozzle comprises a deflector plate to deflect fluid from the second stream exiting the second nozzle outlet.

26-28. (canceled)

29. A system for applying a solution to plant surfaces, the system comprising:
one or more nozzles for creating droplets and/or directing the droplets onto the plant surfaces;
a first container for containing the first liquid;
a second container for containing a second liquid comprising the adjuvant;
a first pump for drawing the first liquid from the first container to at least a first nozzle; and
a second pump for drawing the second liquid from the second container to at least the first nozzle,
wherein the one or more nozzles contact the first liquid and the adjuvant to distribute the adjuvant in sprayed droplets of the first liquid so as to concentrate adjuvant within a partial volume near to the droplet surface (a “cloaking volume”), with lower adjuvant concentration in a bulk interior volume that includes the droplet center, wherein the contacting of the first liquid and the adjuvant occurs before contact of the droplets with the plant surfaces, and wherein the cloaking volume contains concentrated adjuvant for at least a time period up until the droplet strikes the plant surface.

30. The system of claim 29, wherein the second pump provides a lower flow rate of the second liquid than the first liquid.

31. The system of claim 30, wherein the flow rate of the second liquid is less than 1% of the flow rate of the first liquid.

32. The system of 29, wherein the one or more nozzles comprises a nozzle series.

33. The system of claim 32, wherein the nozzle series comprises a line of spaced-apart nozzles positioned for application of sprayed liquid onto corresponding multiple rows of plants.

34-35. (canceled)
